(19) United States
(12) Patent Application Publication
(10) Pub. No.: US 2017/0090670 A1
(43) Pub. Date: Mar. 30, 2017

(54) MITIGATING INTERFERENCE IN CAPACITANCE SENSING

(71) Applicant: SYNAPTICS INCORPORATED, San Jose, CA (US)

(72) Inventors: Matthew Stevenson, San Jose, CA (US); Felix Schmitt, Oakland, CA (US)

(21) Appl. No.: 14/871,391

(22) Filed: Sep. 30, 2015

(51) Int. Cl. G06F 3/041; G06F 3/044

(52) U.S. Cl. CPC G06F 3/0418; G06F 3/044

(57) ABSTRACT

A processing system for capacitive sensing includes functionality for obtaining, based on resulting signals, first capacitive sensor data by performing capacitance sensing with sensor electrodes and a transmitter electrode, the sensor electrodes configured to receive the resulting signals from the transmitter electrode. The processing system further includes functionality for obtaining a profile using the sensor electrodes, estimating an interference measurement based on the first profile. The profile is along a receiver axis of the capacitance sensing, and the interference measurement corresponds to interference. The effects of the interference are mitigated in the first capacitive sensor data using the interference measurement to obtain second capacitive sensor data, and positional information of an input object in a sensing region is determined using the second capacitive sensor data.

### FIELD

This invention generally relates to electronic devices.

### BACKGROUND

Input devices, including proximity sensor devices (also commonly called touchpads or touch sensor devices), are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, one or more embodiments relate to a processing system for capacitive sensing. The processing system includes functionality for obtaining, based on resulting signals, first capacitive sensor data by performing capacitance sensing with sensor electrodes and a transmitter electrode, the sensor electrodes configured to receive the resulting signals from the transmitter electrode. The processing system further includes functionality for obtaining a profile using the sensor electrodes, estimating an interference measurement based on the first profile. The profile is along a receiver axis of the capacitance sensing, and the interference measurement corresponds to interference. The effects of the interference are mitigated in the first capacitive sensor data using the interference measurement to obtain second capacitive sensor data, and positional information of an input object in a sensing region is determined using the second capacitive sensor data.

In general, in one aspect one or more embodiments relate to a method for mitigating interference in capacitance sensing. The method includes obtaining, based on resulting signals, first capacitive sensor data by performing capacitance sensing with sensor electrodes and a transmitter electrode, the sensor electrodes configured to receive the resulting signals from the transmitter electrode. The method further includes obtaining a profile using the sensor electrodes, estimating an interference measurement based on the first profile. The profile is along a receiver axis of the capacitance sensing, and the interference measurement corresponds to interference. The effects of the interference are mitigated in the first capacitive sensor data using the interference measurement to obtain second capacitive sensor data, and positional information of an input object in a sensing region is determined using the second capacitive sensor data.

In general, in one aspect, one or more embodiments relate to an input device for capacitive sensing. The input device includes sensor electrodes for receiving resulting signals from a transmitter electrode. The input device further includes a processing system including functionality for obtaining, based on resulting signals, first capacitive sensor data by performing capacitance sensing with sensor electrodes and a transmitter electrode, the sensor electrodes configured to receive the resulting signals from the transmitter electrode. The processing system further includes functionality for obtaining a profile using the sensor electrodes, estimating an interference measurement based on the first profile. The profile is along a receiver axis of the capacitance sensing, and the interference measurement corresponds to interference. The effects of the interference are mitigated in the first capacitive sensor data using the interference measurement to obtain second capacitive sensor data, and positional information of an input object in a sensing region is determined using the second capacitive sensor data.

Other aspects of the invention will be apparent from the following description and the appended claims.

### BRIEF DESCRIPTION OF DRAWINGS

The preferred exemplary embodiment of the present invention will hereinafter be described in conjunction with the appended drawings, where like designations denote like elements.

FIG. 1 is a block diagram of an example system that includes an input device in accordance with an embodiment of the invention.

FIG. 2 is a diagram of an example sensing region in accordance with one or more embodiments of the invention.

FIG. 3 is a flowchart in accordance with one or more embodiments of the invention.

FIGS. 4, 5, and 6 are examples in accordance with one or more embodiments of the invention.

### DETAILED DESCRIPTION

The following detailed description is merely exemplary in nature, and is not intended to limit the invention or the application and uses of the invention. Furthermore, there is no intention to be bound by any expressed or implied theory presented in the preceding technical field, background, brief summary or the following detailed description.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the present invention provide input devices and methods that facilitate improved usability. In particular, one or more embodiments of the invention are directed to mitigating effects of interference in capacitive sensing using profiles. In one or more embodiments, the interference is input object coupled interference. In other words, the interference may be on the receiver electrodes that an input object, such as a finger, stylus, or pen, is touching. By way of another example, the interference may be due to a noisy charger having common-mode noise. In the noisy charger example, the noisy charger may cause a finger to appear noisy in the capacitive measurements.

One or more embodiments may obtain capacitive sensor data by at least one transmitter electrode transmitting signals and resulting signals being received by a first set of sensor electrodes. A profile is obtained along the same axis as the first set of sensor electrodes. Using the profile, an interference measurement may be estimated and used to mitigate the effects of interference in the sensor data. Thus, positional information for an input object may be determined from the revised sensor data.

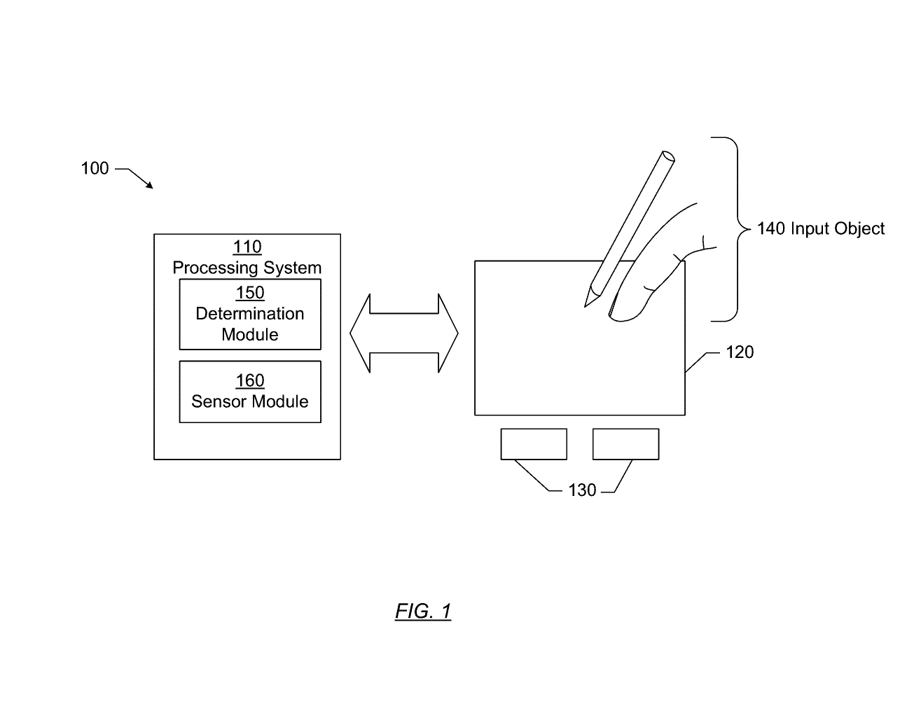

Turning now to the figures, FIG. 1 is a block diagram of an exemplary input device (100), in accordance with embodiments of the invention. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. Further, portions of the input device (100) may be part of the electronic system. For example, all or part of the determination module may be implemented in the device driver of the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad” or a “touch sensor device”) configured to sense input provided by one or more input objects (140) in a sensing region (120). Example input objects include fingers and styli, as shown in FIG. 1. Throughout the specification, the singular form of input object is used. Although the singular form is used, multiple input objects may exist in the sensing region (120). Further, the particular input objects are in the sensing region may change over the course of one or more gestures. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device may be referred to as the above surface sensing region. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher-dimensional spaces. Some implementations are configured to provide projections of input along particular axes or planes. Further, some implementations may be configured to provide a combination of one or more images and one or more projections.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitive implementations of the input device (100), voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may be a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of, or all of, one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one or more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, identify a gesture, determine an action to perform based on the gesture, a combination of gestures or other information, and/or perform other operations.

The sensor module (160) may include functionality to drive the sensing elements to transmit transmitter signals and receive the resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows only a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may be configured for both display updating and input sensing. As another example, the display screen may be operated in part or in total by the processing system (110).

It should be understood that while many embodiments of the invention are described in the context of a fully-functioning apparatus, the mechanisms of the present invention are capable of being distributed as a program product (e.g., software) in a variety of forms. For example, the mechanisms of the present invention may be implemented and distributed as a software program on information-bearing media that are readable by electronic processors (e.g., non-transitory computer-readable and/or recordable/writable information bearing media that is readable by the processing system (110)). Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer-readable storage medium. Examples of non-transitory, electronically-readable media include various discs, physical memory, memory, memory sticks, memory cards, memory modules, and or any other computer readable storage medium. Electronically-readable media may be based on flash, optical, magnetic, holographic, or any other storage technology.

Although not shown in FIG. 1, the processing system, the input device, and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While FIG. 1 shows a configuration of components, other configurations may be used without departing from the scope of the invention. For example, various components may be combined to create a single component. As another example, the functionality performed by a single component may be performed by two or more components.

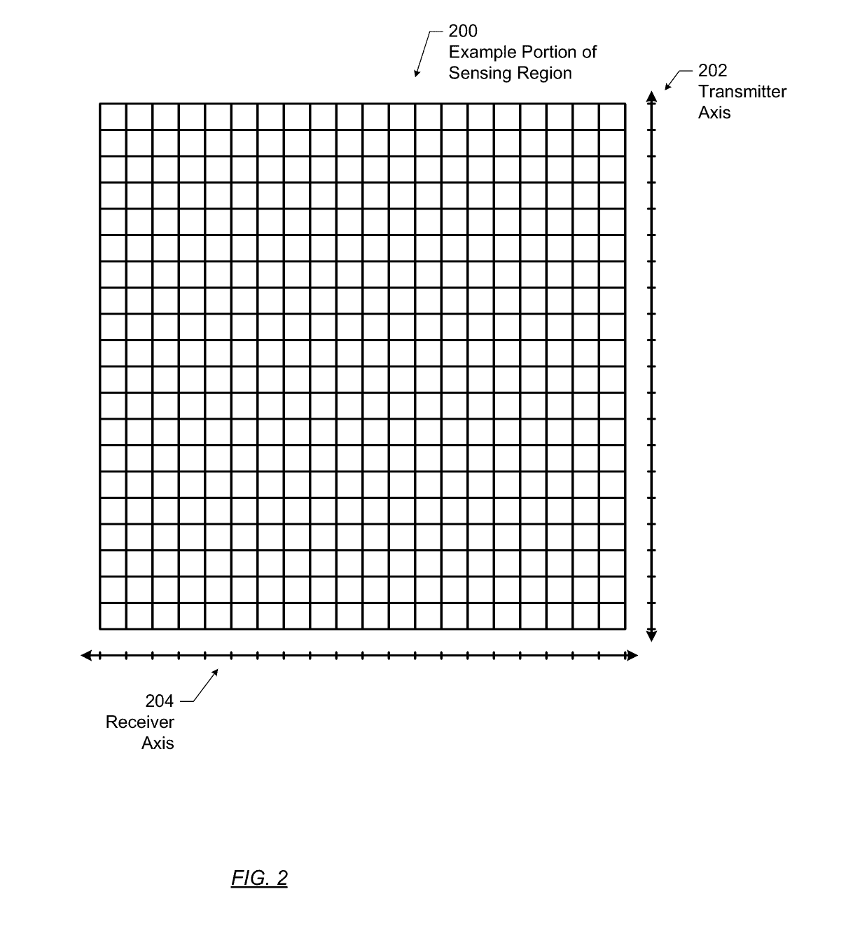

FIG. 2 shows an example diagram of portion of a sensing region (200) in accordance with one or more embodiments of the invention. In one or more embodiments of the invention, the sensing region has a transmitter axis (202) and a receiver axis (204). The transmitter axis (202) has a first set of sensor electrodes that include functionality to transmit sensing signals. The receiver axis includes a second set of sensor electrodes that include functionality to receive sensing signals. For transcapacitive sensing, when a transmitter electrode, or sensing electrode on the transmitter axis, transmit a sensing signal, the resulting signals are received by the receiver electrodes, or second set sensor electrodes, on the receiver axis. Measurements obtained from the resulting signals may be referred to as capacitive sensor data. The measurements that are used may be raw measurements or pre-processed measurements. In one or more embodiments, the capacitive sensor data from performing the mutual capacitance sensing using each transmitter electrode may for a two dimensional capacitive image. In the two dimensional capacitive image, each intersection between the transmitter electrode and the receiver electrodes has a corresponding value.

Continuing with FIG. 2, one or more embodiments may include functionality to perform hybrid sensing. In other words, the input device shown in FIG. 1 may include functionality to obtain one or more profiles from the sensing region. A profile is a single dimensional set of values from the sensing region along a particular axis of the sensing region. For example, a receiver axis profile is a profile obtained along the receiver axis (204) of the sensing region (200). Notably, the receiver axis profile does not reference the function of the sensor electrodes during the acquisition of the profile as being receivers, but rather the function of the sensor electrodes in the corresponding mutual capacitance or active pen sensing. Namely, the receiver axis profile refers to a profile acquired along the sensor electrodes, which, during transcapacitive sensing or active pen sensing, the sensor electrodes are on the receiver axis. Conversely, the transmitter axis profile refers to the profile acquired along the sensor electrodes, which, during the transcapacitive sensing, the sensor electrodes are on the transmitter axis. Thus, rather than being a two dimensional capacitive image of the sensing region, the collection of values in the receiver axis profile or the transmitter axis profile are single dimensional and include a single raw measured value for each hatch mark shown in FIG. 2 on the transmitter axis (202) and receiver axis (204).

As discussed above, FIG. 2 is only an example. The size, shape, number an configuration of electrodes may vary from the example shown in FIG. 2 without departing from the scope of the invention. In particular, although FIG. 2 shows the electrodes as being configured in a grid pattern, the electrodes may be arranged in a different pattern.

Further, although FIG. 2 shows a transmitter axis, for active pen sensing, one or more transmitter electrodes may be in the active pen. In such a scenario, sensor electrodes along the transmitter axis may not be used for the active pen sensing. In one or more embodiments of the invention, the receiver sensor electrodes may receive resulting signals from the transmitter electrode(s) in the active pen. As used herein, regardless of whether the active pen sensing is used or transmitter electrodes on the input device is used, measurements obtained using a transmitter electrode and a separate receiver electrode, that is distinct from the transmitter electrode, may be referred to herein as capacitive sensor data.

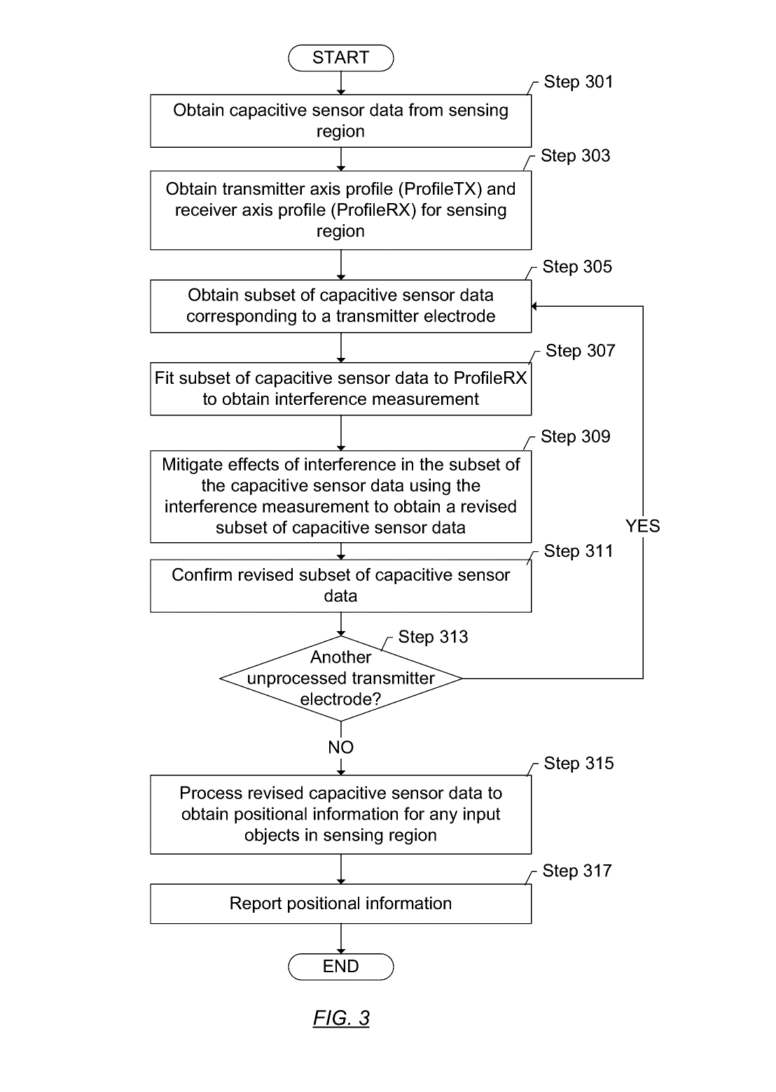

FIG. 3 shows a flowchart in accordance with one or more embodiments of the invention. While the various steps in this flowchart are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

In Step 301, capacitive sensor data from the sensing region is obtained in accordance with one or more embodiments of the invention. In one or more embodiments, the capacitive sensor data is obtained using transcapacitance sensing. In other words, a transmitter electrode transmit sensing signals and the resulting signals are received by sensor electrodes on the receiver axis. The sensor electrodes receiving the resulting signals may receive the resulting signals concurrently. Further, multiple transmitter electrodes may transmit sensing signals concurrently using one or more coding schemes or other such technique.

In one or more embodiments of the invention, active pen sensing is performed. Active pen sensing may supplement or replace the transcapacitance sensing. For example, transcapacitance sensing, active pen sensing, and the acquisition of profiles (discussed below) may be performed in a round robin fashion. In active pen sensing, the transmitter electrode(s) in the active pen transmits the sensing signals. The resulting signals are received by sensor electrodes located along the receiver axis. Measurements may be acquired from the resulting signals. If both active pen and transcapacitance sensing are used, the sensor electrodes along the transmitter axis may be disabled or otherwise not transmit when the active pen sensing is performed in accordance with one or more embodiments of the invention.

Regardless of whether transcapacitance or active pen sensing is performed, the resulting signals includes effects of the sensing signals, any input object in the sensing region, and any interference. In other words, measurements of the resulting signals are affected by input objects in the sensing region, the value of the sensing signals transmitted, and any interference in the sensing region, such as input object coupled noise interference. The resulting signals may additionally include other effects, such as the grounding state of the input device (e.g., whether the input device is in low ground mass mode or high ground mass mode). The resulting signals may be processed to obtain capacitive sensor data. For example, measurements from the resulting signals may be acquired to generate the capacitive sensor data. Temporal and/or spatial filters may be applied to the capacitive sensor data. Similarly, the baseline may be subtracted from the capacitive sensor data prior to proceeding. Alternatively, the aforementioned preprocessing may be performed after the effects of interference in the capacitive sensor data is mitigated as discussed below.

Continuing with FIG. 3, in Step 303, a transmitter axis profile (ProfileTX) and a receiver axis profile (ProfileRX) are obtained for the sensing region. Different types of sensing may be performed to obtain the transmitter axis profile. For example, the transmitter axis profile may be obtained using absolute capacitance sensing. In other words, the sensor electrodes along the transmitter axis may be driven with sensing signals and measurements are acquired from the same sensor electrodes along the transmitter axis. Similarly, a profileRX may be obtained using absolute capacitance sensing. In particular, the sensor electrodes along the receiver axis may be driven with sensing signals and measurements are acquired from the same sensor electrodes along the receiver axis. The profileTX and the profileRX may be obtained from the corresponding measurements. As with the capacitive sensor data, filtering and baseline removal may be performed on profileTX and profileRX.

Although the above is discussed with respect to absolute capacitive sensing, other types of profiles may be used. For example, one method to obtain a profile may be for the transmitter electrodes to transmit sensing signals concurrently not using the same transmitter signal and having the receiver electrodes receive the resulting signals concurrently. In such a scenario, the resulting signals include the effects of each transmitter electrode that transmitted. Measurements from the resulting signals may correspond to a profileRX. A similar operation may be performed for profileTX, except that the sensor electrodes along the receiver axis transmit concurrently using the same signal and the sensor electrodes along the transmitter axis receive concurrently in order to obtain the profileTX.

In Step 305, a subset of the capacitive sensor data is acquired in accordance with one or more embodiments of the invention. The subset corresponds to a portion of the capacitive sensor data corresponding to a transmitter electrode when the data corresponds to transcapacitive measurements or to an individual time sample when the data corresponds to an active pen measurement. In other words, for transcapacitive measurements, the subset acquired is the portion that resulted from the transmitter electrode on the input device transmitting sensing signals. For active pen, the subset acquired corresponds to a burst of the active pen in accordance with one or more embodiments of the invention. One or more embodiments individually, although possibly concurrently, processes each subset of the capacitive sensor data corresponding to the transmitter electrode.

In Step 307, the subset of the capacitive sensor data is fit to the ProfileRX to obtain an interference measurement in accordance with one or more embodiments of the invention. In particular, the noise in the capacitive sensor data is proportional to the noise in the profileRX. In other words, for a single transmitter electrode, the amount of the effects of interference present at the position in which an input object touches the sensing region, and the position of the finger coupled noise in the image is the same in the profileRX. Additionally, the effects of interference in the profileRX is proportional to the effects of interference in the capacitive sensor data. Thus, fitting technique may be applied to profileRX to determine effects of interference in the subset of the capacitive sensor data. In one or more embodiments, the effects may be reflected in the noise amplitude or the single amount that each value in the profileRX increased because of the interference. Thus, the interference measurement may be a noise amplitude increased amount. One fitting technique that may be used is a least squares fit. However, other fitting techniques may be used without departing from the scope of the invention.

In Step 309, the effects of interference in the subset of the capacitive image is mitigated using the interference measurement to obtain a revised subset of the capacitive image in accordance with one or more embodiments of the invention. For example, using the fitting technique in Step 307, a value of the interference measurement may be obtained. In Step 309, the value may be subtracted from each value in the capacitive sensor data to obtain a revised capacitive sensor data. The mitigation may be to correct for or remove the effects of interference. In other embodiments, the mitigation may reduce the effects of interference. However, some effects of interference may remain present after the mitigation.

In Step 311, the revised subset of the capacitive sensor data may be confirmed in accordance with one or more embodiments of the invention. In other words, a validation procedure may be applied to the revised subset of the capacitive sensor data. In particular, by the nature of a fitting technique, not only effects of noise may be accounted for in the interference measurement, but also effects of the input object. Thus, the mitigation in Step 309 may unintentionally reduce the effects of an input object in the sensing region. Different techniques may be applied to confirm the revised subset of the capacitive sensor data based on whether the capacitive sensor data reflects an active pen signal or a transcapacitive signal.

If the capacitive sensor data reflects the active pen signal, then the following validation procedure may be applied. First, using the revised subset of the capacitive sensor data may be used to detect the position of the pen. In other words, the position of the pen may have a peak that remains after the interference measurement is subtracted from the subset of the capacitive sensor data. Based on the position of the pen, a fitting procedure may be applied to the profileRX. More particularly, in the profileRX, the fitting procedure omits the values that correspond to the position of the pen when estimating the interference measurement. Thus, the fitting procedure, such as least squares fit, does not fit data that may correspond to effects of the pen in the sensing region when estimating a second interference measurement because the subset of the profileRX corresponding to the active pen is omitted when performing the analysis. As a result, the second interference measurement may provide a more accurate measurement of the effects of interference over the first interference measurement. The second interference measurement may be subtracted from the capacitive sensor data obtained in Step 301 for processing in Step 315 (discussed below).

Notably, in accordance with one or more embodiments of the invention, if a finger is not close to the sensor, then the active pen may be the only coupling of this noise into the pen bursts. The technique described in Steps 307 and 309 may fail to correctly identify the effects of interference and may remove the legitimate pen signal perfectly, leading to a complete non-detection of the pen. In one or more embodiments, an additional check is performed as follows. If the total values on the profileRX is less than or equal to a threshold amount that is expected from just a pen, then Steps 307 and 309 may be skipped for the current frame of data.

Continuing with Step 311, a different technique may be applied to confirm the revised capacitive sensor data when the capacitive sensor data corresponds to transcapacitive measurements. In particular, the values of the subset of the revised capacitive sensor data corresponding to the transmitter electrode designated in Step 305 may be summed to obtain a total value. The total value may be compared with the profileTX value at the position of the transmitter electrode. If the total value is less than the profileTX value, then the mitigation in Step 309 included mitigating effects of an input object. In such a scenario, the values of the revised capacitive sensor data along the transmitter electrode are increased until the total matches in accordance with one or more embodiments of the invention.

In Step 313, a determination is made whether another unprocessed transmitter electrode exists in accordance with one or more embodiments of the invention. In particular, one or more embodiments may iterate through the transmitter electrodes. Rather than iterating through all transmitter electrodes, one or more embodiments may iterate only through the transmitter electrodes in which an input object may be present. In other words, an initial pass of clump detection may be performed on the capacitive sensor data to identify sub-regions of the sensing region that may have an input object. Any subset of the capacitive sensor data that does not have a possible input object may have the corresponding transmitter electrodes removed from further processing. If another unprocessed transmitter electrode exists, the flow may return to Step 305 to process the next transmitter electrode.

In Step 315, the revised capacitive sensor data is processed to obtain positional information for any input objects in the sensing region. For example, processing the revised capacitive image may be performed using segmentation to identify clumps in the revised capacitive image, performing peak detection for each clump, filtering erroneous input objects (e.g., palms or other large input objects) based on size and other attributes of the clumps, and performing other processing. In one or more embodiments, for each clump, the position of an input object may correspond to a peak in a clump. Thus, the position may be added as part of the positional information. Additional information, such as the size of the clump and the value in the capacitive sensor data at the position, may be added to the positional information.

In Step 317, the positional information is reported. For example, the input device may report the positional information to the host device. If the host device executes the all or part of the processing system, the processing system may report the positional information to a host operating system, or the host operating system may report the positional information to an application. Regardless of the sender and the recipient of the positional information, the host device may perform an action based on the positional information. For example, the host device may change the state of the display in the user interface, change the state of the host device or perform another action.

Although the above is discussed with respect to correcting for input object coupled interference or interference due to a charger, one or more embodiments may be applied to low ground mass correction. In particular, similar to interference due to a charger or input object, effects of low ground mass may be proportional in the capacitive sensor data as in the profileRX. Thus, when the effects of interference are mitigated, the effects of the low ground mass may also be mitigated.

Further, although not presented in FIG. 3, one or more embodiments may mitigate effects of interference in the profiles (e.g., profileTX, profileRX). In particular, the interference on the receiver axis is proportional to the profileRX. Noise on the profileTX may be corrected by identifying subsets of the capacitive sensor data that is negative. For any negative subset, the negative subset may be changed to zero. Then using the corrected capacitive sensor data, the profileRX and the profileTX may be corrected by reversing the confirmation method discussed above with respect to Step 315. In other words, rather than using profileTX to correct the capacitive sensor data, the relationship discussed in Step 315 may be used to correct the profileTX from the capacitive sensor data.

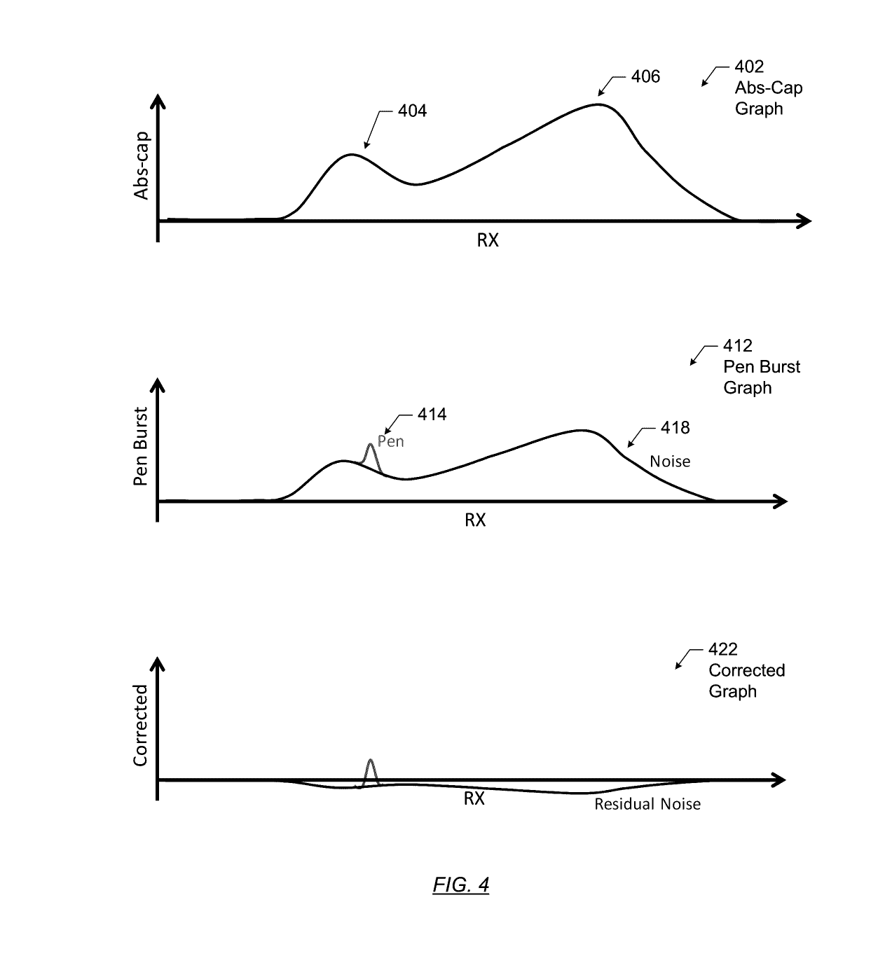

FIGS. 4, 5, and 6 show examples in accordance with one or more embodiments of the invention. The examples in FIGS. 4, 5, and 6 are for example purposes only and not intended to limit the scope of the invention.

FIG. 4 shows an example set of graphs for a pen in accordance with one or more embodiments of the invention. In particular, FIG. 4 shows an example of an Abs-Cap graph (402) of an absolute capacitive profile obtained along a receiver axis. As shown in FIG. 4, even though a single pen is in the sensing region, multiple peaks (e.g., 404, 406) are present in the abs-cap graph (402). The peaks indicate a presence of input object coupled interference.

The pen burst graph (412) in FIG. 4 shows a graph of the pen burst (414) and the graph of the noise (418) as reflected by the receiver electrodes when performing active pen sensing using a transmitter electrode on the active pen. Although FIG. 4 separates out the pen from the noise, the processing system may not be able to distinguish, directly from the graph, the pen from the noise.

The corrected graph (422) shows the correction performed using the technique described above with reference to FIG. 3. In particular, a fit analysis is performed on the abs-cap graph (402) to obtain an interference measurement that is subtracted from the pen burst graph (412). The result is the corrected graph (422) in FIG. 4. As shown by the negative measurements in the corrected graph, overfitting may have occurred causing some of the effects caused by the pen to be erroneously removed. The negative measurements may be referred to as residual noise. The corrective procedure discussed above with reference to FIG. 3 may be applied to remove the residual noise.

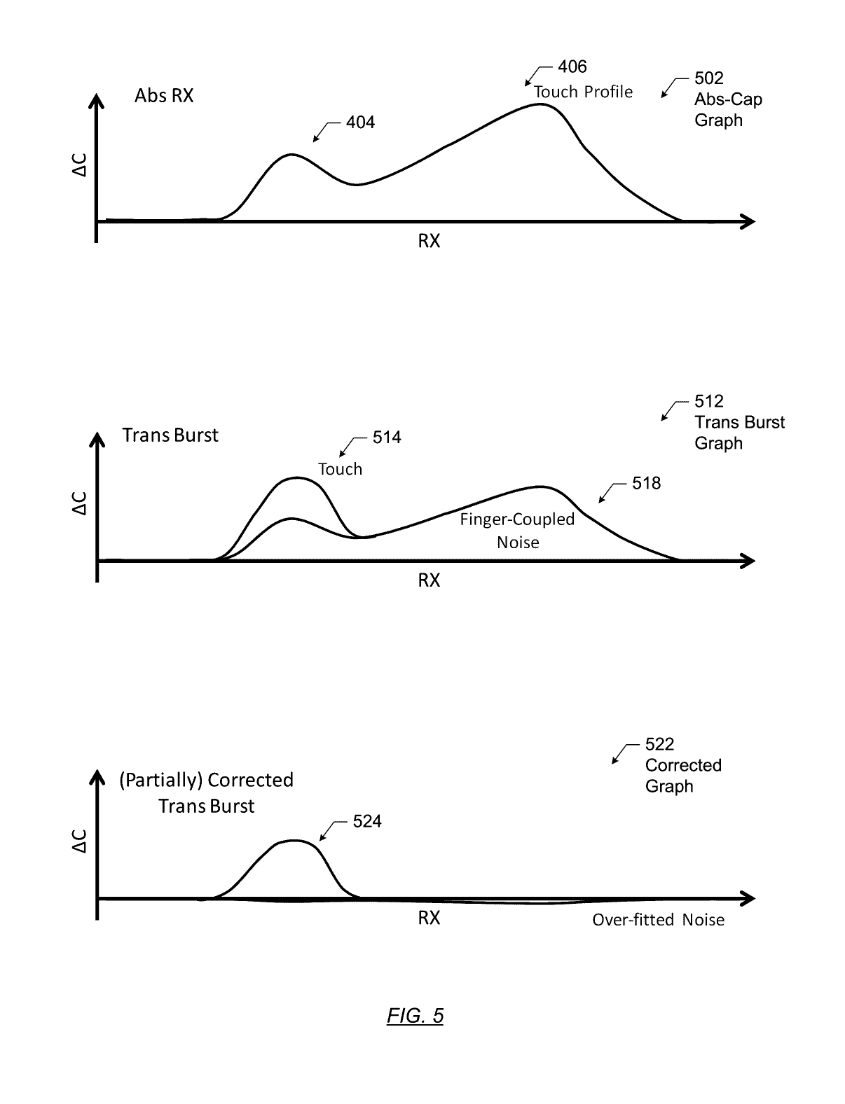

Turning to FIG. 5, shows an example set of graphs for a finger in accordance with one or more embodiments of the invention. In particular, FIG. 5 shows an example of an Abs-Cap graph (502) of an absolute capacitive profile obtained along a receiver axis. Abs-Cap graph (502) shows data for a portion of the sensing region having a single finger. As shown in FIG. 5, even though a single finger is in the portion of the sensing region, multiple peaks (e.g., 504, 506) are present in the abs-cap graph (502). The peaks indicate a presence of input object coupled interference.

The trans burst graph (512) in FIG. 5 shows a graph of the position of the touch (514) for the portion of the sensing region, and the graph of the noise (518) as reflected by the receiver electrodes when performing capacitive sensing using transmitter electrodes on the input device. In other words, in FIG. 5, the burst corresponds to the subset of the capacitive sensor data having a finger and corresponding to a transmitter electrode. Although FIG. 5 separates out the finger from the noise, the processing system may not be able to distinguish, directly from the graph, the finger from the noise.

The corrected graph (522) shows the correction performed using the technique described above with reference to FIG. 3. In particular, a fit analysis is performed on the abs-cap graph (502) to obtain an interference measurement that is subtracted from the trans burst graph (512). The result is the corrected graph (522) in FIG. 5. As shown by the negative measurements in the corrected graph, overfitting may have occurred causing some of the effects caused by the finger to be erroneously removed. The negative measurements may be referred to as residual noise. The corrective procedure discussed above with reference to FIG. 3 may be applied to remove the residual noise.

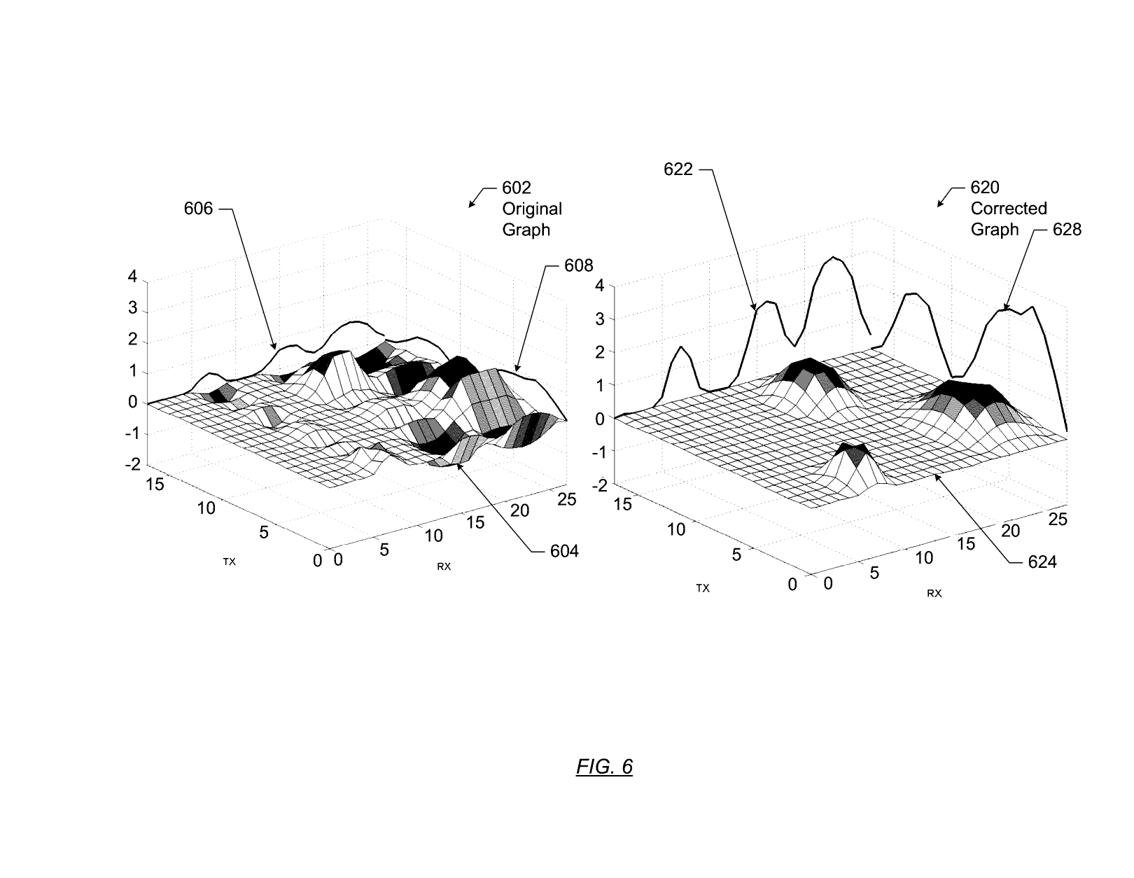

FIG. 6 shows an example simulation using one or more embodiments of the invention. The original graph (602) shows profile data and capacitive sensor data that are affected by finger-coupled noise, display noise, and low ground mass. As shown in the capacitive sensor data (604), the positions of the input objects may be indistinguishable from other peaks because of the low ground mass and noise. Using the receiver axis profile (606), a measure of interference and low ground mass may be estimated. The estimated amount may be subtracted from the capacitive sensor data (604) to obtain corrected graph (620). Further, the transmitter axis profile (608) may be used to perform a consistency check.

As shown in the corrected graph (620), the peaks of the input objects are readily distinguishable from the surrounding measurements in the revised capacitive sensor data (624). Using the revised capacitive sensor data, the transmitter axis profile (628) and the receiver axis profile (624) may also be corrected. Thus, one or more embodiments may be used by a computing device to identify positions of input objects in the sensing region.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

Thus, while the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A processing system for capacitive sensing, the processing system comprising functionality for:
obtaining, based on resulting signals, first capacitive sensor data by performing capacitance sensing with a first plurality of sensor electrodes and a transmitter electrode, the first plurality of sensor electrodes configured to receive the resulting signals from the transmitter electrode;
obtaining a first profile using the first plurality of sensor electrodes, the first profile being along a receiver axis of the capacitance sensing;
estimating a first interference measurement based on the first profile, the first interference measurement corresponding to interference;
mitigating effects of the interference in the first capacitive sensor data using the interference measurement to obtain second capacitive sensor data; and
determining positional information of an input object in a sensing region using the second capacitive sensor data.

2. The processing system of claim 1, wherein performing the capacitive sensing comprises:
transmitting transmitter signals with a second plurality of sensor electrodes and receiving the resulting signals using the first plurality of sensor electrodes, wherein the resulting signals comprises effects corresponding to the transmitter signals, wherein the second plurality of sensor electrodes comprises the transmitter electrode.

3. The processing system of claim 1, wherein the first capacitive sensor data corresponds to a plurality of active pen signal measurements, wherein performing the capacitance sensing comprises receiving the resulting signals using the first sensor electrodes, the resulting signals corresponding to the transmitter electrode being in an active pen device.

4. The processing system of claim 3, wherein the processing system is further configured to estimate the first interference measurement when the first profile is above an active pen threshold level.

5. The processing system of claim 1, wherein estimating the first interference measurement is performed by fitting the first capacitive sensor data to the receiver axis profile.

6. The processing system of claim 1, wherein estimating the first interference measurement is performed using a fitting technique.

7. The processing system of claim 1, further comprising functionality for:
obtaining a second profile using a second plurality of sensor electrodes,
confirming the second sensor data using the second profile.

8. The processing system of claim 1, further comprising functionality for:
confirming the second sensor data by:
determining a position of an active pen device using the second sensor data,
estimating a second interference measurement based on the first profile by omitting profile measurement in the first profile corresponding to the position, and
mitigating effects of the interference in the second sensor data using the second interference measurement.

9. The processing system of claim 1, further comprising functionality for:
removing the interference reflected in the first profile.

10. A method for mitigating interference in capacitance sensing, the method comprising:
obtaining, based on resulting signals, first capacitive sensor data by performing capacitance sensing with a first plurality of sensor electrodes and a transmitter electrode, the first plurality of sensor electrodes configured to receive the resulting signals from the transmitter electrode;
obtaining a first profile using the first plurality of sensor electrodes, the first profile being along a receiver axis of the capacitance sensing;
estimating a first interference measurement based on the first profile, the first interference measurement corresponding to interference;
mitigating effects of the interference in the first capacitive sensor data using the interference measurement to obtain second capacitive sensor data; and
determining positional information of an input object in a sensing region using the second capacitive sensor data.

11. The method of claim 10, wherein performing the capacitive sensing comprises:
transmitting transmitter signals with a second plurality of sensor electrodes and receiving the resulting signals using the first plurality of sensor electrodes, wherein the resulting signals comprises effects corresponding to the transmitter signals, wherein the second plurality of sensor electrodes comprises the transmitter electrode.

12. The method of claim 10, wherein the first capacitive sensor data corresponds to a plurality of active pen signal measurements, wherein performing the capacitance sensing comprises receiving the resulting signals using the first sensor electrodes, the resulting signals corresponding to the transmitter electrode being in an active pen device.

13. The method of claim 10, wherein estimating the first interference measurement is performed by fitting the first capacitive sensor data to the receiver axis profile.

14. The method of claim 10, wherein estimating the first interference measurement is performed using a fitting technique.

15. The method of claim 10, further comprising:
obtaining a second profile using a second plurality of sensor electrodes,
confirming the second sensor data using the second profile.

16. The method of claim 10, further comprising:
confirming the second sensor data by:
determining a position of an active pen device using the second sensor data,
estimating a second interference measurement based on the first profile by omitting profile measurement in the first profile corresponding to the position, and
mitigating effects of the interference in the second sensor data using the second interference measurement.

17. The method of claim 10, further comprising:
removing the interference reflected in the first profile.

18. An input device for capacitive sensing comprising:
a first plurality of sensor electrodes for receiving resulting signals from a transmitter electrode; and
a processing system configured to:
obtain, based on the resulting signals, first capacitive sensor data by performing capacitance sensing with the first plurality of sensor electrodes and a transmitter electrode;
obtaining a first profile using the first plurality of sensor electrodes, the first profile being along a receiver axis of the capacitance sensing;
estimating a first interference measurement based on the first profile, the first interference measurement corresponding to interference;
mitigating effects of the interference in the first capacitive sensor data using the interference measurement to obtain second capacitive sensor data; and
determining positional information of an input object in a sensing region using the second capacitive sensor data.

19. The input device of claim 18, wherein performing the capacitive sensing comprises:
transmitting transmitter signals with a second plurality of sensor electrodes and receiving the resulting signals using the first plurality of sensor electrodes, wherein the resulting signals comprises effects corresponding to the transmitter signals, wherein the second plurality of sensor electrodes comprises the transmitter electrode.

20. The input device of claim 18, wherein the first capacitive sensor data corresponds to a plurality of active pen signal measurements, wherein performing the capacitance sensing comprises receiving the resulting signals using the first sensor electrodes, the resulting signals corresponding to the transmitter electrode being in an active pen device.
